(19) United States
(12) Patent Application Publication
(10) Pub. No.: US 2013/0298389 A1
(43) Pub. Date: Nov. 14, 2013

(54) METHOD AND APPARATUS FOR MANUFACTURING AN ELECTROCHEMICAL ENERGY STORE

(71) Applicant: Claus-Rupert Hohenthanner, Hanau (DE)

(72) Inventor: Claus-Rupert Hohenthanner, Hanau (DE)

(73) Assignee: Li-Tec Battery GmbH, Kamenz (DE)

(21) Appl. No.: 13/883,611

(22) PCT Filed: Oct. 28, 2011
(86) PCT No.: PCT/EP2011/005476

§ 371 Date: Jul. 18, 2013

(30) Foreign Application Priority Data
Nov. 8, 2010 (DE) 10 2010 050 743.1

(51) Int. Cl. H01M 4/04; H01M 4/02

(52) U.S. Cl. CPC H01M 4/0402; H01M 4/02
USPC 29/623.5; 29/730

(57) ABSTRACT

In a method for producing an electrode stack for an electrochemical energy store, in which anodes (5) and cathodes (8) are stacked alternately and in each case are separated by at least one separator (6, 7), at least one anode (5) or cathode (8) and at least one separator (6,7) are supplied. The at least one anode (5) or cathode (8) and the at least one separator (6, 7) are gripped by at least one gripper (19, 20, 21, 22, 24-29) and deposited to form the electrode stack.

The present invention relates to a method and an apparatus for manufacturing an electro-chemical energy store.

U.S. Pat. No. 5,456,000 describes a method for manufacturing a secondary lithium-ion battery in which electrode, electrolyte and separator elements in the form of layers of plasticized polymeric matrix compositions are laminated so as to form a unitary battery cell structure. U.S. Pat. No. 5,470,357 is part of the same family as the preceding document.

U.S. Pat. No. 5,688,293 describes a method for manufacturing a rechargeable electrochemical cell having a porous separator element between two electrodes in which at least one of the electrodes or the separator is provided a layer of a paste containing a gelling polymer in which an electrolytic active material is dispersed. The two electrodes are thereby fixed on opposite sides of the separator element. The document discloses a manufacturing device having four parallel running rolls, whereby, however, no stacking of the materials is necessary.

U.S. Pat. No. 6,287,721 B1 describes a manufacturing method and a corresponding system for manufacturing electrochemical cells, particularly polymer lithium-ion batteries. In the manufacturing, discrete anodes having laterally offset leads are longitudinally positioned next to each other on an elongate planar separator consisting of an elastic material. Corresponding cathodes having laterally offset leads of corresponding size are positioned on the opposite side of the separator. The substrate is thereupon folded so as to form a folded electrode stack.

U.S. Pat. No. 6,752,842 B2 describes the manufacturing of a flexible thin electrochemical cell using a lamination process, wherein the cell comprises a plurality of layers containing two electrodes separated by a separator. The electrodes are thereby laminated onto the separator.

DE 102 16 677 A1 describes a method for manufacturing lithium polymer cells from an anodic and cathodic mass prefabricated as a film strip having an integrated electrolyte and an insulating pasty intermediate phase as a separator therebetween, according to which the electrode masses, the separator and at least one electrolyte stream are fed separately to a processing unit in which the masses are combined, the separator exposed to and filled with the electrolyte stream directly prior to said combining, the combined masses rolled together with the supplied electrolyte and compressed into a cellular composite which is subsequently housed in the processing unit in a form suitable for use as a cell, contacted, welded and provided with packaging material.

The present invention is based on the object of specifying the most effective technical teaching possible for manufacturing electrochemical energy stores which can prevent or overcome the potential disadvantages or limitations of the known methods to the greatest extent possible. This object is accomplished by a method, respectively a product, in accordance with any one of the independent claims. The subclaims relate to advantageous further developments of the invention.

According to the invention, a method is provided for manufacturing an electrode stack for an electrochemical energy store in which anodes (5) and cathodes (8) are alternatingly stacked and in each case separated by at least one separator (6, 7). In the process, the following steps are preferably realized:
supplying at least one anode (5) or cathode (8);
supplying at least one separator (6,7);
the at least one anode (5) or cathode (8) and the at least one separator (6, 7) being gripped by means of at least one gripper (19, 20, 21, 22, 24-29); and
depositing the gripped objects (5, 6, 7, 8) to form an electrode stack.

In accordance with the invention, an apparatus for manufacturing an electrode stack for an electrochemical energy cell is additionally provided which has a first feeder device (1, 4) for supplying at least one anode (5) or cathode (8), a second feeder device (2, 3) for supplying at least one separator (6, 7) and at least one gripper (19, 20, 21, 22, 24-29) for gripping the at least one anode (5) or cathode (8) and the at least one separator (6, 7) and depositing the gripped objects (5, 6, 7, 8) so as to form an electrode stack.

The feeder devices are preferably designed as conveyor devices, particularly preferably as parallel running belts for supplying anodes, cathodes and separators. The inventive apparatus preferably comprise a plurality of grippers (24, 25, 26, 27, 28, 29) movably arranged longitudinally on at least one axis (9, 10, 11, 12, 13, 14, 15, 16, 23) aligned perpendicular to the parallel running belts (1, 2, 3, 4).

Within the meaning of the present invention, an electrochemical energy store is to be understood as any device which stores energy in chemical form and can release it in electrical form. Important examples of electrochemical energy stores are galvanic cells or assemblies of multiple galvanic cells. Particularly encompassed hereby are electrically chargeable (“secondary”) electrochemical energy stores which can electrically absorb energy and store the absorbed energy in chemical form.

An electrode stack refers to an assembly of at least two electrodes and a separator arranged between two respective electrodes. An electrode stack thereby serves in the storing of chemical energy and its conversion into electrical energy. In the case of secondary energy stores, the electrode stack can also serve in converting electrical energy into chemical energy.

In the sense of the present invention, an anode is to be understood in correspondence with the usual linguistic usage as that electrode where oxidation occurs, thus that chemical reaction in which a substance to be oxidized gives off electrons. Correspondingly, a cathode is to be understood as an electrode where reduction occurs, whereby electrons transfer to a molecule. In the case of a discharged galvanic element, the anode is negatively charged and the cathode is positively charged. When charging a galvanic element, oxidation is induced by electrons being withdrawn at the positively charged anode. The anode is in this case the positive terminal; the cathode is correspondingly the negative terminal.

At least one electrode of the electrochemical energy store, particularly preferentially a cathode, preferably comprises a compound of the LiMPO4 formula, whereby M is at least one transition metal cation from the first row of the periodic table of the elements. The transition metal cation is preferably selected from among the group consisting of manganese (Mn), iron (Fe), nickel (Ni) and titanium (Ti) or a combination of these elements. The compound preferably exhibits an olivine structure whereby iron (Fe) is particularly preferential. Particularly (Mg,Fe,Mn)SiO4, CaMnSiO4 (glaucochroite), Ca2SiO4, Al2BeO4 (chrysoberyl), Mg2GeO4, LiFePO4 and Na2BeF4 crystallize in the olivine structure.

In other embodiments of the invention, at least one electrode of the electrochemical energy store, particularly preferentially at least one cathode, preferably comprises a lithium manganate, preferably LiMn2O4 of spinel type, a lithium cobalate, preferably LiCoO2, or a lithium nickelate, preferably LiNiO2, or a mixture of two or three of these oxides, or a lithium-mixed oxide containing manganese, cobalt and/or nickel.

A separator is any device which is suited to preventing an electrical short circuit between an anode and a cathode, wherein at the same time ion transport is enabled through the separator, or through an electrolyte moistening or filling the separator respectively, so that an electrochemical reaction can occur. Separators which do not or only poorly conduct electrons and which consist of an at least partially material-permeable substrate are preferably used in conjunction with the invention.

One preferential substrate is preferably coated on at least one side with an inorganic material. An organic material preferably designed as non-woven fibrous material is preferably used as the at least partially material-permeable substrate. The organic material which preferably comprises a polymer, and particularly preferentially a polyethylene terephthalate (PET), is coated with an inorganic, preferably ion-conducting material which is further preferably ion-conducting in a temperature range of from −40°C. to 200° C. The inorganic material preferentially comprises at least one compound from among the group of oxides, phosphates, sulfates, titanates, silicates and aluminosilicates having at least one of the elements of zirconium (Zr), aluminum (Al) or lithium (Li), particularly preferentially zirconium oxide (zirconia). It is particularly preferential for the inorganic ion-conducting material to comprise particles having diameters not exceeding 100 nm.

An example of one such separator is marketed in Germany by Evonik AG under the brand name of “Separion.”

In conjunction with the present invention, electrodes, thus anodes or cathodes, and separators are preferably sheet-like objects which are preferably punched from corresponding films running on parallel belts of an apparatus for manufacturing an electrochemical energy store. In accordance with a preferred embodiment of the invention, it is provided for two objects from a group of objects comprising anodes, cathodes and separators to be gripped together by at least one gripper and added to an electrode stack. The concerted gripping of at least two objects can thereby occur in different ways.

According to one preferred embodiment of the invention, it is provided for at least two objects from among a group of objects comprising anodes, cathodes and separators to be gripped at the same time by different grippers and added to an electrode stack. Another preferred embodiment of the invention provides for at least two objects from among a group of objects comprising anodes, cathodes and separators to be cumulatively gripped by at least one gripper in succession and added to an electrode stack. The expression “cumulatively gripped” is hereby to mean that a respective gripper first grabs a first object and then, without depositing the first gripped object beforehand, grasps at least one second object and thereafter adds both or all or some of the objects to an electrode stack together, for example by depositing both objects together on an electrode stack.

According to one preferred embodiment of the invention, it is provided for at least one preferably sheet-like object to be at least partially permeable to air and be grasped by a vacuum gripper. A vacuum gripper thereby refers to a special type of gripper which uses low pressure to suction an object to be gripped, wherein the object to be gripped is pressed to the vacuum gripper due to the higher ambient pressure (normal pressure) prevailing on the other side of said object to be gripped. It is particularly preferential for partially air-permeable, preferably sheet-like objects to be used in conjunction with such embodiments of the invention in which at least two objects are cumulatively gripped in succession by a vacuum gripper.

According to a further preferred embodiment of the invention, it is provided for at least one first object to exhibit a larger surface than at least one second object. This is then particularly advantageous when upon a cumulative grasping of at least two objects by a vacuum gripper, the first gripped object has a smaller surface than the subsequently gripped object because the excessive surface of the larger object can thereby still be subjected to the vacuum effect of the vacuum gripper. It is particularly advantageous in the present and other embodiments of the invention for an annular gap to be provided around at least one preferably sheet-like object. The annular gap is preferably formed such that after an object having a smaller surface is grasped, an annular gap remains in which a larger object still to be grasped is subjected to the vacuum effect of the vacuum gripper.

According to a further preferred embodiment of the invention, it is provided for objects cumulatively gripped in succession to be deposited together onto an electrode stack. The cumulative grasping of a plurality of objects allows an appreciable reduction in transport times to be realized, which favorably impacts the manufacturing throughput rate.

An apparatus comprising a plurality of grippers movably arranged longitudinally on at least one axis aligned perpendicular to the parallel running belts is preferably used to realize the method.

A further preferential embodiment of the invention provides for an apparatus comprising at least one anode belt, at least one cathode belt and at least one separator belt arranged between each anode belt and each cathode belt. An apparatus having at least one anode belt, at least one cathode belt and at least two separator belts arranged between each anode belt and each cathode belt is particularly preferable.

The apparatus for realizing the inventive method preferably comprises a device for stacking objects between the at least two separator belts. The stacking device is preferably designed in some embodiments of the invention such that objects are also temporarily deposited onto a stack and at least parts thereof can then be taken off of said stack again.

In some embodiments of the invention, objects are preferably placed atop or overlain one another in offset and/or rotated manner relative one another when stacking. The concept of placing such objects atop one other or overlaying them is to be understood in this context as the creating or maintaining of an arrangement of said objects in which the surfaces of the objects are in contact. The surfaces of the objects thereby preferably lie substantially perpendicular to the direction of gravity. In terms of the present description of the invention, the objects are placed atop and offset relative one another when they are deposited atop one another so as to be displaced or offset each other in a direction tangential to their surfaces. They are placed in rotated fashion atop one another when they are deposited atop one another so as to be rotated about an axis perpendicular to their surfaces. These offsetting, displacing or rotating procedures can also be combined in any desired manner when overlaying the objects.

In accordance with a preferred embodiment, the invention provides for at least one first object to be held while at least one second object lying above the at least one first object is removed. In terms of the present description of the invention, a second object thereby lies above a first object in correspondence with the usual linguistic usage when the second object exerts the force of its weight on the first object.

One preferred embodiment of the invention provides for at least one first object to be held while at least one second object lying above the at least one first object is removed by a pressure being exerted from above onto at least one point or one part of said object. The at least one point or at least one part of said object is thereby preferably at the edge of the object's surface. This embodiment of the invention in particular has proven particularly advantageous when the preferably sheet-like objects exhibit a lower inherent stability, particularly a inherent stability than sheet-like objects made of paper, which is frequently the case with electrode or separator materials for constructing electrochemical energy stores.

It is particularly preferential when the objects employed are at least partially air-permeable objects. The inventive preferably offset and/or rotated depositing of the preferably sheet-like objects allows a particularly effective, reliable and simple separating of these preferably sheetlike objects, particularly when they have a tendency to adhere to another one somewhat due to their material properties and associated adhesion or coherence or when a vacuum lifter suctions a plurality of them, particularly in the case of at least partially air-permeable objects. It is likewise preferentially provided for at least one sheet-like object to be an electrode or a separator for constructing an electrochemical energy store or a part of such an electrode or separator.

It is preferably provided to use a lifting device rotatable about a vertical axis and/or displaceable in a horizontal plane to remove and/or deposit objects, said lifting device being aligned and/or positioned by means of a device which recognizes the position of an object to be removed using information technology. Preferred lifting devices are thereby mechanical gripping devices, electrostatic lifting devices or vacuum lifters. Feasible as devices for recognizing the position of an object to be removed are thereby all devices which are suited to recognizing the position of an object to be removed using information technology, preferably by means of signal processing and particularly preferably by means of pattern recognition.

In the positioning and/or aligning of the lifting device rotatable about a vertical axis and/or displaceable in a horizontal plane using a device which recognizes the position of an object to be removed using information technology, the operative elements of the lifting device, preferably the suction cups of a vacuum lifter, are preferably aligned and/or positioned such that said operative elements of the lifting device cover as much as possible of the surface of the object to be removed, particularly lifted, and that said operative elements of the lifting device preferably do not come into contact or interact with other objects, particularly those underneath the object to be lifted or removed.

Further or the already cited embodiments of the invention preferably provide for at least one lifting device, particularly preferably a vacuum lifter, which is arranged on a lifting apparatus so as to be rotatable about a vertical axis and/or displaceable in a horizontal plane. The vertical axis is thereby preferably arranged substantially parallel to the direction of gravity and thus substantially orthogonal to the surfaces of the object to be deposited or lifted. The horizontal plane is preferably aligned perpendicular to the vertical axis.

The present or further embodiments of the invention preferably exhibit at least one hold-down element which holds at least one first object while at least one second object lying above the at least one first object is removed. In this context, a hold-down element refers to any device which is suited to holding a first object lying underneath a second object; i.e. preventing it from being lifted together with the object to be lifted due to adhesive or cohesive force. Preferably conceivable as hold-down elements are mechanical gripping devices, electrostatic retaining devices or hold-down elements operated by means of negative pressure or vacuum.

The hold-down element is preferably rigidly connected to the vacuum lifter or to the other lifting device or at least connected such that a relative motion between the hold-down element and the vacuum lifter is then not possible when the vacuum lifter or other lifting device moves horizontally relative a deposited or positioned object.

At least one vacuum lifter thereby preferably comprises a plurality of pressure chambers. Said pressure chambers can preferably be subjected to a vacuum independently of one another. It is particularly preferable for the pressure chambers to be arranged horizontally displaceable to one another. This is associated with the advantage of being able to adapt the position of the pressure chambers to the form of the preferably sheet-like object.

The inventive assembly preferably comprises an IT device for recognizing the position of an object to be removed. The inventive assembly preferably likewise comprises an IT device for aligning and/or positioning a lifting device based on the position of the object to be removed as recognized by the same or by a further IT device. The IT device for recognizing the position of an object to be removed thereby preferably comprises a camera.

The features of the described and other embodiments of the invention can be advantageously combined with features of further embodiments.

The following will draw on preferred embodiments in association with the accompanying figures in describing the invention in greater detail. Shown are:

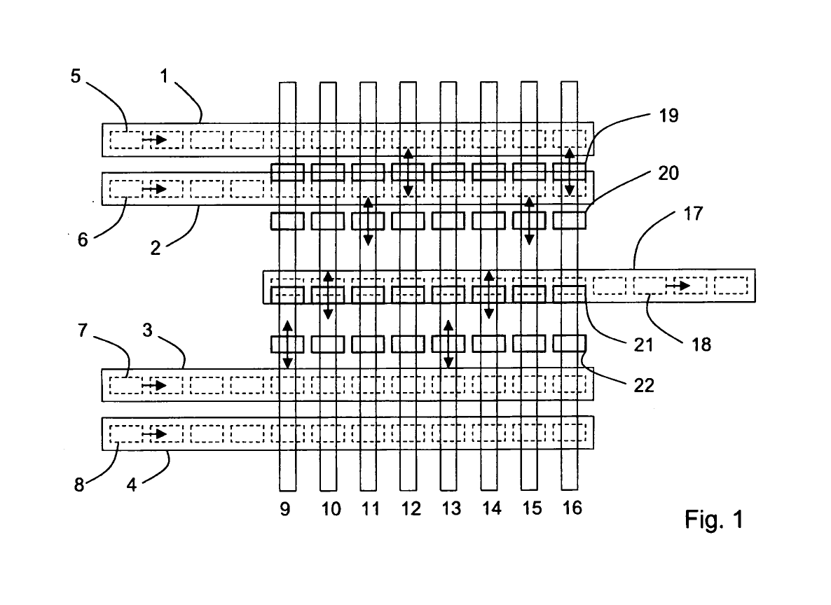

FIG. 1 a schematic plan view of a detail from an inventive manufacturing apparatus in accordance with a preferred embodiment of the invention;

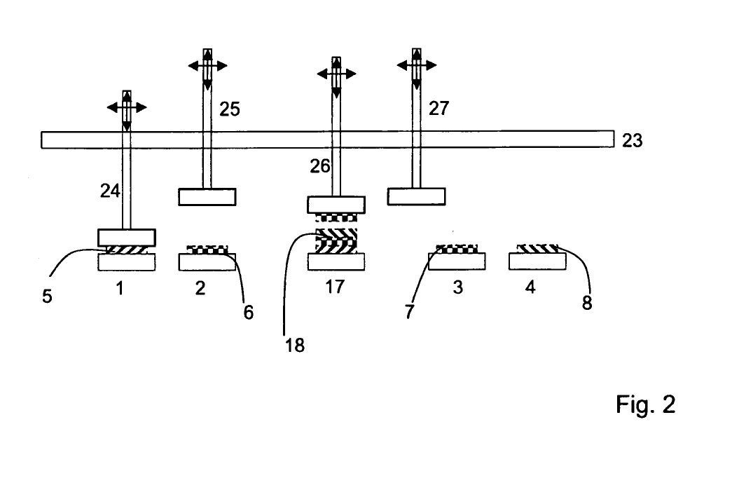

FIG. 2 a schematic view of a cross section through an apparatus for realizing the inventive method according to a preferred embodiment of the invention;

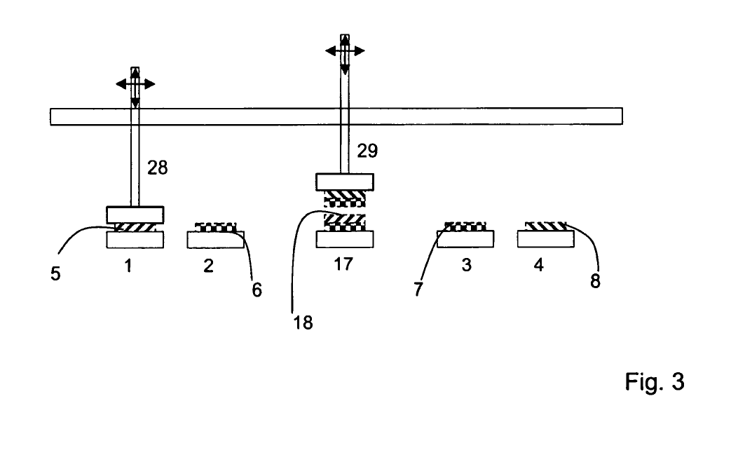

FIG. 3 a schematic view of a cross section through an apparatus for realizing the inventive method according to a further preferred embodiment of the invention; and

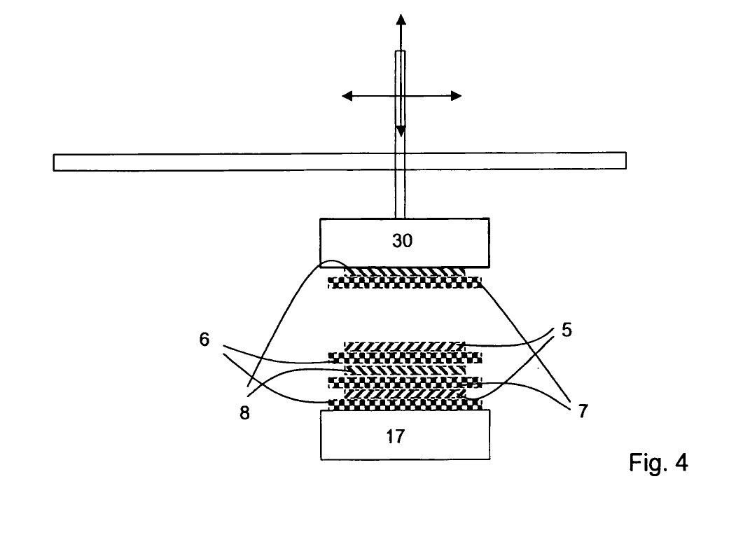

FIG. 4 a detail of an apparatus for realizing the inventive method according to a preferred embodiment of the invention.

One preferred embodiment of an inventive apparatus is depicted schematically in FIG. 1. As indicated by the arrow, the apparatus is continuously fed anodes 5 on an only partially depicted belt 1 from left to right. Separators 6 are supplied to the apparatus on belt 2 running parallel thereto. The apparatus is similarly fed cathodes 8 on belt 4 and separators 7 on belt 3. A device 17 for stacking preferably sheet-like objects is provided between the parallel running belts 1, 2, 3 and 4, same preferably being likewise designed as a conveyor device so that assembled electrode stacks 18 can be removed from left to right. Axes 9, 10, 11, 12, 13, 14, 15 and 16 on which grippers 19, 20, 21, 22 are movably arranged are disposed perpendicular to said conveyor devices, said grippers provided for grasping the preferably sheet-like objects, electrodes and/or separators and depositing them on the device 17 for stacking electrode stacks.

The grippers can be movably arranged longitudinal to the axes and perpendicular to the figure plane independently of one another such that said grippers can assemble the electrodes and/or separators grasped on belts 1, 2, 3 and 4 on the device 17 for depositing and/or stacking preferably sheet-like objects into electrode stacks in which respective neighboring electrodes are separated by at least one separator.

The process of assembling electrodes and/or separators into electrode stacks is depicted schematically in FIG. 2. In this embodiment of the invention, four grippers 24, 25, 26 and 27 are arranged along axis 23 and vertically movable such that said grippers can grasp electrodes 5 and 8 as well as separators 6 and 7 from belts 1, 2, 3 and 4 and add them to an electrode stack 18 on device 17.

The gripper shown in FIG. 2 can thereby be configured such that it is also suited to cumulatively gripping a plurality of preferably sheet-like objects.

FIG. 3 shows a variant of the assembly shown in FIG. 2 in which only two grippers 28 and 29 are provided, wherein gripper 28 is shown at the stage of gripping an electrode 5 from belt 1 in order to subsequently add it to an electrode stack 18 on the deposit device 17, preferably after said gripper 28 has first grasped separator 6 from belt 2 without beforehand depositing electrode 5. The cumulative grasping is shown in FIG. 3 using the example of gripper 29 which is depicted at a stage in which it has cumulatively grasped an electrode 8 and a separator 7 in order to deposit both preferably sheet-like objects on the electrode stack 18 together.

This process is illustrated somewhat more clearly again in FIG. 4, where the gripper 30 transports an electrode 8 having a smaller surface than separator 7. The gripper 30 has cumulatively grasped both preferably sheet-like objects in order to now deposit them on an electrode stack on deposit device 17 which already consists of a series of electrodes of unlike poles separated in each case by a separator 6 / 7. Since an anode is shown as the uppermost electrode 5 on the electrode stack, adding the cumulatively gripped preferably sheet-like objects 7 and 8 still in the gripper results in a functioning electrode stack.

1. A method for manufacturing an electrode stack for an electrochemical energy store in which anodes and cathodes are alternatingly stacked and in each case separated by at least one separator, the method comprising the steps:
supplying at least one anode or cathode;
supplying at least one separator;
gripping the at least one anode or cathode and the at least one separator by at least one gripper to form gripped objects; and
depositing the gripped objects to form an electrode stack, using a lifting device that is rotatable about a vertical axis and/or displaceable in a horizontal plane to remove and/or deposit objects,
wherein said lifting device is aligned and/or positioned by a device that recognizes, using information technology, a position of an object to be removed.

2. The method according to claim 1, wherein at least two objects from among a group of objects comprising anodes, cathodes and separators are gripped together by at least one gripper and added to an electrode stack.

3. The method according to claim 2, wherein at least two objects from among a group of objects comprising anodes, cathodes and separators are gripped simultaneously by different grippers and added to an electrode stack.

4. The method according to claim 2, wherein at least two objects from among a group of objects comprising anodes, cathodes and separators are cumulatively gripped by at least one gripper in succession and added to an electrode stack.

5. The method according to claim 4, wherein at least one object is at least partially permeable to air and grasped by a vacuum gripper.

6. The method according to claim 4 wherein at least one first object comprises a larger surface than at least one second object.

7. The method according to claim 4, wherein an annular gap is provided around at least one object.

8. The method according to claim 4, wherein objects cumulatively gripped in succession are deposited together onto an electrode stack.

9. An apparatus for manufacturing an electrode stack for an electrochemical energy store comprising:
a first feeder device to supply at least one anode or cathode;
a second feeder device to supply at least one separator
at least one gripper to grip the at least one anode or cathode and the at least one separator, the gripped objects being deposited to form an electrode stack;
a lifting device rotatable about a vertical axis and/or displaceable in a horizontal plane to remove and/or deposit objects; and
a device to recognize a position of an object to be removed using information technology and to position and/or align the lifting device accordingly.

10. The apparatus according to claim 9, further comprising:
parallel running belts to supply anodes, cathodes and separators; and
a plurality of grippers movably arranged longitudinally on at least one axis and aligned perpendicular to the parallel running belts.

11. The apparatus according to claim 10 comprising at least one anode belt, at least one cathode belt and at least one separator belt arranged between each anode belt and each cathode belt.

12. The apparatus according to claim 11 comprising at least one anode belt, at least one cathode belt and at least two separator belts arranged between each anode belt and each cathode belt.

13. The apparatus according to claim 12 comprising a device to stack sheet-shaped objects between the at least two separator belts.
